(19) United States
(12) Patent Application Publication
(10) Pub. No.: US 2018/0253691 A1
(43) Pub. Date: Sep. 6, 2018

(54) Systems and Methods for Delivering Products to a Customer

(71) Applicant: Walmart Apollo, LLC, Bentonville, AR (US)

(72) Inventors: Donald R. High, Noel, MO (US); Bruce W. Wilkinson, Rogers, AR (US); Brian G. McHale, Chadderton Oldham (GB); Parvez Musani, Bentonville, AR (US); Matthew A. Jones, Bentonville, AR (US); Todd D. Mattingly, Bentonville, AR (US); Robert L. Cantrell, Herndon, VA (US); John J. O'Brien, Farmington, AR (US)

(21) Appl. No.: 15/911,509

(22) Filed: Mar. 5, 2018

Related U.S. Application Data
(60) Provisional application No. 62/467,608, filed on Mar. 6, 2017.

(51) Int. Cl. G06Q 10/08; G06Q 30/06; G06Q 50/28

(52) U.S. Cl. CPC G06Q 10/08355; G06Q 50/28; G06Q 30/0641; G06Q 10/0833

(57) ABSTRACT

In some embodiments, apparatuses and methods are provided herein useful to deliver products to a customer at a landmark or rendezvous location, as opposed to a set street or mailing address. In some configurations, a retail product delivery system may include electronic user devices of delivery agents and customers, a shopping user interface and a delivery user interface, and a control circuit. By one approach, the control circuit receives a retail order from a particular customer, monitors individual activity of the particular customer, presents a selection opportunity permitting the particular customer to select a landmark or rendezvous location for delivery of the shipment, and instruct delivery of the shipment to the particular customer at the landmark or rendezvous location. In one aspect, the control circuit facilitates interaction between the electronic user devices of the particular customer and the assigned delivery agent.

### CROSS-REFERENCE TO RELATED APPLICATION(S)

This application claims the benefit of U.S. Provisional Application No. 62/467,608, filed Mar. 6, 2017, which is incorporated by reference in its entirety herein.

### TECHNICAL FIELD

This invention relates generally to delivery of retail products to customers.

### BACKGROUND

Customers generally desire efficient and effective use of their time. Accordingly, many customers seek to have products delivered to them to avoid having to pick up products at a retail facility or a shipping or distribution center. While package delivery is a service frequently used by many customers, it remains an area of the shopping experience that could be improved. For example, customers often need to be available at a home address to receive packages that require signature or delays in shipping or delivery of a product may render it less than useful for its intended purpose.

### BRIEF DESCRIPTION OF THE DRAWINGS

Disclosed herein are embodiments of systems, apparatuses and methods pertaining to delivery of products to a customer location. This description includes drawings, wherein:

FIG. 1 is a schematic illustration of an exemplary system for delivery of products in accordance with some embodiments.

FIG. 2 is an exemplary flow diagram in accordance with several embodiments.

FIG. 3 illustrates an exemplary system for use in implementing systems, apparatuses, devices, methods, techniques, and the like for delivering products to customers in accordance with some embodiments.

FIG. 4 comprises an illustration of blocks as configured in accordance with various embodiments of these teachings.

FIG. 5 comprises an illustration of transactions configured in accordance with various embodiments of these teachings.

FIG. 6 comprises a flow diagram in accordance with various embodiments of these teachings;

FIG. 7 comprises a process diagram as configured in accordance with various embodiments of these teachings.

FIG. 8 comprises an illustration of a delivery record configured in accordance with various embodiments of these teaching.

FIG. 9 comprise a system diagram configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to deliver products to a user or customer at a landmark or rendezvous location, as opposed to a home address such as a set street or mailing address. By one approach, a system can evaluate a customer's itinerary, plans, schedule, or calendar, among other sources of information, to determine where, when, and how the retail products can be effectively delivered to a customer who is or will be away from their home mailing address. For example, as opposed to receiving a specific street address, the system may facilitate delivery of the retail order to person who is traveling away from home or will be traveling away from home at the time of the delivery. While some customers may have submitted an order so late that the retail facility may not have time to receive, fulfill, and deliver an order before the expected departure of the customer, the customer also may desire not to have to bring the shipment with them while traveling and may prefer that the items meet them at or near their future destination.

In some embodiments, a retail product delivery system for delivering products to a customer away from a home address or another street address includes electronic user devices of delivery agents and customer recipients, a shopping user interface configured to operate on an electronic user device and a delivery user interface configured to operate on an electronic user device, and a control circuit. By one approach, the control circuit is configured to receive a retail order from a particular customer, monitor individual activity associated with the particular customer including a present location thereof, via an electronic user device associated with the particular customer, present a selection opportunity, via the shopping user interface, based, in part, on readings from the electronic user device associated with the particular customer, (the selection opportunity permitting the particular customer to select a landmark or rendezvous location for delivery of the retail order or a portion thereto), and instruct delivery of the retail order or the portion thereof to the particular customer at the landmark or rendezvous location, via the delivery user interface operating on an electronic user devices associated with the delivery agents. In one illustrative approach, the customer is not located in the landmark or rendezvous location at the time of selecting the location for delivery thereof. In this manner, the customer is able to plan on where their travels or plans will bring them at the time of expected delivery. Further, as noted below, the selection opportunities presented to the particular customer may be based on the customer's itinerary or calendar activities, among other details. As used herein, the interfaces may include a mobile application that is configured to work on a mobile device such as a smartphone or tablet, among other light and portable electronic devices.

When receiving the retail order, the control circuit may be configured to receive delivery requests from the particular customer. For example, if a customer knows they will be away from home on a delivery date or would otherwise like the retail order or portions thereof (i.e., shipment) to be delivered somewhere else, the customer may select such a delivery option when submitting the retail order. In another configuration, such a request may be submitted after initial submission of a retail order. By one approach, the control circuit may have access to a customer's itinerary (or calendar, social media profile, or other personal information) from the electronic device associated with the particular customer, from which the control circuit can detect a future intended location of the customer such that the control circuit may suggest a landmark or rendezvous location for delivery of the shipment. Accordingly, in some configurations, the control circuit may analyze the information, such as the customer itinerary, and identify alternative delivery locations to present to the particular customer via the shopping user interface, in response to a determination that the particular customer is scheduled to be away from an initial delivery location.

In one exemplary embodiment, separate and distinct delivery agents are crowd-sourced. To facilitate delivery of retail products (from retail orders or portions thereof), the system may have a delivery user interface configured to operate on electronic user devices. In this manner, the system permits the delivery agents to register as a delivery agent. Further, the control circuit may present a delivery opportunity to one or more delivery agents via the delivery user interface. By one approach, the control circuit monitors locations of a plurality of delivery agents via the electronic user interfaces associated therewith. The control circuit may evaluate this information when considering what delivery agents to task with delivery of a particular shipment.

By another approach, the control circuit detects whether one of the delivery agents is within a predetermined distance from at least one of: a distribution location, a shipping location, another delivery agent with a delivery location proximate the landmark or rendezvous location of a particular retail order, or the landmark or rendezvous location of the particular retail order. In this manner, the control circuit may assign or task one of the delivery agents with delivery of an order or portion thereof based on their location or proximity to, for example, one of the above. As noted below, the delivery of a shipment may employ a number of different delivery agents responsible for different portions of the route. In addition to matching the shipment (i.e., the retail order or portion thereof) with a delivery agent proximate the shipping location (or another location), the system may look to other factors to ensure satisfactory delivery of the shipment. To that end, the system may further include a delivery agent database having capabilities of at least a plurality of delivery agents and associated delivery vehicles therein. The system may consider these capabilities when assigning or tasking a particular delivery agent with delivery of a shipment. For example, large shipments may require sufficient cargo space for delivery thereof. The delivery agent database may have information on the type of vehicle available for delivery of the shipment. In addition to using a delivery vehicle for delivery of the shipments, some of the delivery agents may be couriers using alternative modes of transportation such as bicycle or simply delivering the shipment by foot.

As noted above, the control circuit may monitor locations of delivery agents via electronic user devices of the delivery agents. Further, the electronic delivery agents may accept a potential delivery opportunity via the agent's associated electronic device. To that end, the electronic user devices may have a delivery user interfaces operating thereon such that the delivery agents may register to deliver shipments, accept potential shipments, and/or receive routing information, among other activities.

In one illustrative approach, the control circuit also monitors a delivery agent location of an assigned delivery agent tasked with delivery of the retail order or the portion thereof and notifies the particular customer, via the electronic user device associated with the particular customer and the assigned delivery agent, via the one of the electronic user devices associated with the assigned delivery agent, when the particular customer and the assigned delivery agent are within a predetermined distance from one another. In this manner, a customer and an assigned delivery agent are notified when they are in proximity to one another. For example, at a popular music festival, there may be a large number of people located at a landmark, and therefore, providing the customer and delivery agent notification when they are proximate one another may help them locate one another to complete delivery. Further, upon determining that the customer and the assigned delivery agent are within the predetermined distance from one another, the control circuit may facilitate interaction between the electronic user device of the particular customer and the assigned delivery agent. By facilitating interaction with the two electronic devices, the particular customer and the assigned delivery agent may be in direct contact with one another.

As a customer's plans change, their intended location or intended destination at a given time may change. Accordingly, the system herein may permit a customer to update their intended location or destination. Indeed, the system may detect the change in travel plans, calendar, or itinerary. In one embodiment, by monitoring the individual activity of the particular customer, the system can receive notification of a change of an intended location of the particular customer. In this manner, the control circuit may reroute the retail order or the portion thereof during delivery. To that end, the control circuit may analyze multiple delivery agent locations, via the electronic user devices carried thereby, and in response to receiving notice of a change of the customer's intended location, rerouting the retail order or portion thereof to another delivery agent for delivery. By rerouting the order or portion thereof, the delivery agent may be provided with an updated landmark or rendezvous location, updated delivery route, and/or may be instructed to deliver the shipment to another delivery agent. The new delivery agent typically assumes responsibility of taking the shipment to the new or updated landmark or rendezvous location or to yet another delivery agent or retail facility or shipping or distribution center for alternative delivery.

To facilitate secure interaction with and accurate transactions amongst the devices described herein, the control circuit may be configured to authenticate the particular customer and assigned delivery agents. To that end, the system may employ a blockchain protocol. By one approach, the control circuit authenticates delivery of the retail order or the portion thereof by securely storing data in data blocks so that it cannot be modified after storage. To that end, the system may include a computer memory storing computer readable instructions configured to create a genesis block of a chain, compute a hash of the genesis block, and create a proof standard of the chain. In this manner, the chain is stored on multiple nodes as at least one of a distributed database or a shared ledger such that modifications to any one copy of the chain would be detectable when the system attempts to achieve consensus prior to adding a new block to the chain. In another aspect, at least some of the blocks in the chain are created by nodes that include at least one of: the particular customer via the electronic user device associated therewith, a retail entity via the control circuit, or an assigned delivery agent. Furthermore, the control circuit may authenticate delivery of the retail order or portion thereof via DNA labeling and the system further comprises a DNA scanner and a delivery agent database having profiles of the delivery agents.

In one exemplary approach, a method for delivery products to customers away from a home address or another street address includes receiving a retail order from a particular customer, monitoring individual activity of the particular customer including a present location, present a selection opportunity, via a shopping user interface configured to operate on the electronic user interface associated with the particular customer where the selection opportunity allows the customer to select a landmark or rendezvous location for delivery of the retail order or a portion thereof (i.e., a shipment), and instruct delivery of the retail order or the portion thereof to the particular customer at the landmark or rendezvous location, via a delivery user interface operating on a delivery agent user device.

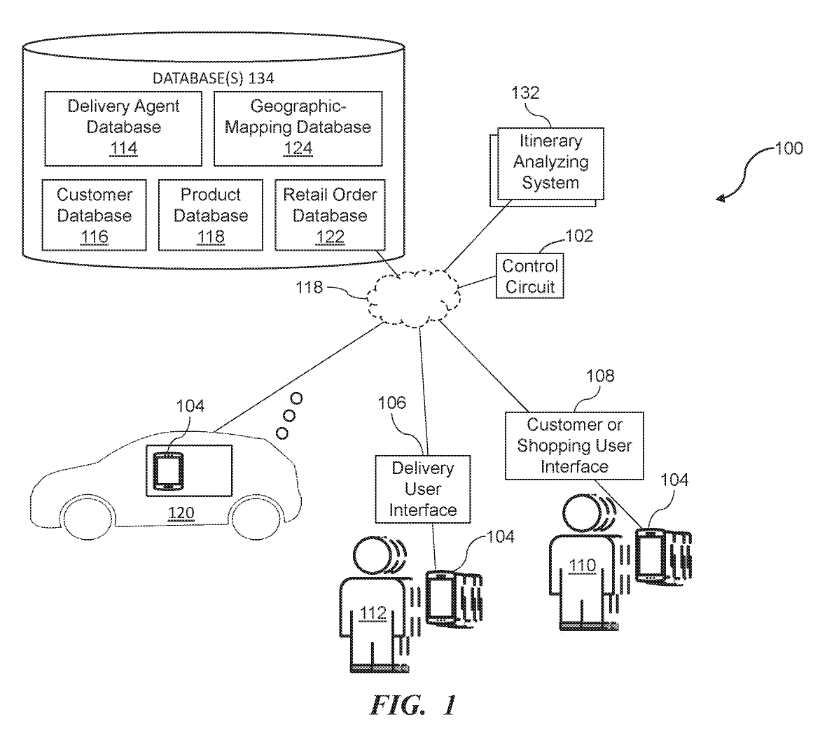

FIG. 1 illustrates a retail product delivery system 100 that permits a customer to receive or accept delivery of a shipment at a location other than a street address, like a home address. To facilitate such delivery, the system 100 typically includes a number of electronic user devices 104, which may be carried by shoppers or customers 110 or delivery agents 112. By one approach, the electronic user devices 104 may operate one or more interfaces, such as a delivery user interface 106 and/or a customer or shopping user interface 108. By one approach, the delivery system 100 includes a control circuit 102 that is in communication with at least some of the electronic user devices 104 that have the shopping user interface 108 and/or the delivery user interface 106 operating thereon.

In one illustrative approach, the control circuit 102 receives a retail order from a particular customer, such as via the shopping user interface. The retail order typically includes one or more retail products sold by a retail facility. During receipt of the retail order, the control circuit also may receive payment information from the customer for the retail order. When the retail order is submitted or around the time of order submission, the customer may elect to have the retail order or a portion thereof delivered to a location besides their home or another mailing address as outlined below.

The retail order may be provided to a central computer, server, or the control circuit 102 either directly or indirectly, such as through a network 118. In some configurations, the network 118 also may communicate information to or from one of the databases 134. As illustrated in FIG. 1, the control circuit 102, the electronic user devices 104, the delivery user interface 106, the customer or shopping user interface 108, the itinerary analyzing system 132, and/or the database(s) 134, if present, may be communicatively coupled, either directly or indirectly, such as over one or more distributed communication networks 118, which may include, for example, LAN, WAN, Internet, cellular, Wi-Fi, and other such communication networks or combinations of two or more of such networks.

In another aspect, the control circuit 102 monitors individual activity of the particular customer associated with the retail order, such as, for example, by monitoring or tracking activity of the electronic user device associated with the particular customer. By one approach, monitoring the individual activity of the particular customer includes monitoring their present location. In this manner, as the particular customer moves, travels, or otherwise continues with their plans, the control circuit 102 generally has an up-to-date information on the particular customer's location. In one configuration, the control circuit 102 tracks the present location of the particular customer in real-time.

In addition to tracking the present location of the particular customer, monitoring the individual activity of the particular customer also may include, for example, analyzing the particular customer's calendar, travel plans or itinerary, social media posts, or purchasing history, among other items, such that the control circuit 102 may use information beyond the present location of the particular customer to forecast where the particular customer will be and when. In this manner, the control circuit 102 can provide suggestions on where the particular customer may arrange to meet with a delivery agent to receive their retail or portion thereof.

In one illustrative approach, the control circuit 102 is configured to receive delivery requests from the particular customer and/or a customer itinerary from the particular customer, such as, for example, from the electronic user device associated with the particular customer. With this information, the control circuit may analyze the customer itinerary and identify delivery locations to present to the particular customer, such as, via the shopping user interface. By one approach, the control circuit identifies alternative delivery locations to present to the particular customer in response to a determination that the particular customer is scheduled to be away from an initial delivery location or a home street address. In another aspect, the control circuit 102 considers delivery times to present to the particular customer in addition to potential delivery locations, such as landmark or rendezvous locations.

By one approach, the control circuit 102 may employ a number of delivery agents to deliver a single shipment, as outlined below. Multiple delivery agents may be used, for example, when the delivery agents available for assignment of a delivery are not able to complete the entire delivery route, when an assigned delivery agent may not have sufficient time to complete delivery (such as, for example, if there is unexpected traffic on the delivery route), after an unexpected change in the customer's plans render an updated delivery location necessary, or when a landmark location closures requiring an updated delivery location. In such circumstances, the control circuit 102 may analyze the databases 134, as described below, to determine what additional or alternative delivery agents can be used to deliver the shipment and the control circuit 102 may provide such delivery opportunities to one or more delivery agents. As noted above, the system 100 may employ separate and distinct crowd-sourced delivery agents, and thus, multiple types of different delivery agents may be involved in the delivery of shipments to customers. In one configuration, the system 100 may use a mesh of delivery agents where a single shipment may pass through multiple delivery agents, such as, for example, in a relay race, on route to a customer. Such a mesh network of delivery agents may be managed by a central system such as system 100 and may be reconfigurable during delivery. To that end, the system may provide for an authentication method for delivery agents to authenticate themselves as the delivery transitions from agent to agent, such as, using the blockchain protocol described below.

In another aspect, the control circuit 102 presents a selection opportunity, such as via the shopping user interface, allowing the particular customer to select a landmark or rendezvous location for delivery of the retail order or a portion thereof. The selection opportunities presented, in one configuration, are based, at least in part, on readings from the electronic user device associated with the particular customer. In another aspect, the selection opportunity is based, in part, on information about the expected individual activity of the particular customer. As noted above, the control circuit 102 may be in receipt of a variety of information indicating the particular customer's plan(s) and these may be analyzed to determine and suggest selection opportunities to the particular customer. In one exemplary approach, the selection opportunities are generally not the same as the present location of the particular customer such that when selected the user is not presently located in the rendezvous or landmark location.

As noted above, the control circuit 102 may receive and consider a number of different pieces of information when forecasting where the particular customer is likely to be at a particular point in time. Based on this information, the control circuit 102 presents the selection opportunity. Before such presentation, the control circuit 102 may consider rendezvous or landmark location options for presentation. These may include a number of well know, readily identifiable, accessible, and/or highly visible locales such as, for example, public fountains, portions of a public library, fair grounds, large sculptures or public works of art, train stations, fieldhouses, pavilions, bridges, water towers, or other structures, among others. While the control circuit 102, in one embodiment, may provide selection opportunities to the particular customer for selection thereof, in another configuration, the particular customer may initiate or suggest a landmark or rendezvous location.

Upon selection (or suggestion) of a landmark or rendezvous location by the particular customer, the control circuit 102, by one approach, instructs delivery of the retail order or portion thereof to the particular customer at the landmark or rendezvous location. In one embodiment, this occurs via the delivery agent or delivery user interface operating on an electronic user device associated with the assigned delivery agent. By instructing the delivery, the control circuit 102 may present a delivery opportunity to a number of different delivery agents such that one of the delivery agents may choose or select to be assigned the delivery. In another configuration, the control circuit 102 may determine the delivery agent most suitable for the delivery and assign the delivery to that delivery agent (such as by giving that most suitable delivery agent an opportunity to deliver the shipment before the opportunity is offered to others).

By way of example, the control circuit 102 may access a database, such as one of the databases 134, to assist in a determination of which delivery agent 112 may be most appropriate for delivery of a shipment. FIG. 1 illustrates a number of databases 134 to which the control circuit 102 may have access via the network 118. The databases 134 illustrated include a delivery agent database 114, a customer database 116, a product database 118, a retail order database 122, and a geographic mapping database 124. For example, the delivery agent database 114 may include information on a plurality of delivery agents 112, their present location, their current route, and their capabilities, such as the size, and availability of any associated delivery vehicles 120, cargo or hauling capacity, among other details. In another example, the retail order database 112 includes a plurality of retail orders including information on the number and kind of products or items in the retail order. Further, the product database 118 may include information on the products such as, for example, information such as the size, weight, temperature requirements, configuration of the items or products so that the control circuit 102 can determine the delivery requirements of retail orders.

In this manner, the control circuit 102 may determine whether a particular delivery agent has the capabilities to deliver certain shipments or packages to a certain location at a certain time. Also, the control circuit 102 may have information from the customer (such as can be found in a customer profile) regarding customer preference on delivery methods and these can be accessed and matched to potential delivery agents in the delivery agent database. Once a particular delivery agent has been identified for delivery of the shipment (before, during, or shortly after assigning the delivery), the control circuit 102 may access the geographic-mapping database 124 to develop a delivery route for the assigned delivery agent. Further, depending on events in and around the route, the route may be updated during delivery of the shipment to account for changes in circumstances.

The delivery agents 112 mentioned herein may be crowd-sourced via a plurality of delivery user interfaces operating on electronic user devices. In this manner, the delivery agents may be separate and distinct entities. In one aspect, the control circuit 102 is configured to present a delivery opportunity to one or more delivery agents via the delivery user interface. Further, the delivery user interface may be executed within or on the electronic user devices of the separate and distinct delivery agents. The delivery agent interface (or the customer-shopping user interface) may be provided to the electronic user devices by the control circuit or may be configured to be executed by the electronic devices when in communication with the control circuit.

In one illustrative approach, the control circuit 102, detects whether one of the delivery agents is within a predetermined distance from a distribution location, a shipping location, another delivery agent such as an agent with a shipment having a delivery location proximate the landmark or rendezvous location of another retail order, and/or the landmark or rendezvous location of the particular retail order, among other locations. By another approach, the control circuit 102 monitors locations of a plurality of delivery agents via the electronic user interfaces associated therewith.

The control circuit 102 also may analyze the various databases 134 and determine that a number of the retail orders or portions should be delivered together. For example, if a particular customer has requested delivery of a shipment at a train station shortly after train arrival, other train riders may be interested in having their shipments delivered to the train station such that a single delivery agent might be able to deliver a number of different retail orders or portions thereof to a number of different customers. In this manner, a delivery agent may wait or loiter around the train station until the travelers have arrive.

In one exemplary configuration, the control circuit 102 monitors a delivery agent location of an assigned delivery agent tasked with delivery of the shipment and notifies the particular customer and the assigned delivery agent (via their respective electronic user devices) when the two are in proximity to one another. For example, when the particular customer and the assigned delivery agent are within a predetermined distance from one another the control circuit, may notify both of the parties. Accordingly, the particular customer and the assigned delivery agent may now look or be watching for one another. Further, in one configuration, upon a determination that the particular customer and the assigned delivery agent are within the predetermined distance from one another, the control circuit 102 facilitates interaction between the electronic user devices associated with the particular customer and the assigned delivery agent. This feature may be particularly helpful when the rendezvous or landmark location chosen as the delivery location is particularly crowded, dark or otherwise partially obscured (such as by inclement weather or fog), or in the event of street or area closures, among other factors that may render delivery more difficult.

Further, based on changing plans or circumstances (such as closed or crowded locations), the particular customer may determine that a new or updated rendezvous or landmark location should be set for delivery of the shipment. Accordingly, by one approach, the control circuit is configured to receive notification of a change of intended location of the particular customer such that a new or updated delivery location is needed. In this circumstance, the control circuit is configured to reroute the shipment during delivery thereof. Such dynamic delivery permits real-time response to changes in the customer's needs, destination, and location.

By one approach, the originally assigned delivery agent may be provided a new route to the updated delivery location, such as, for example, by having the control circuit 102 access the geographic-mapping database 124. In another configuration, the control circuit 102 is configured to analyze multiple delivery agent locations (via the electronic user devices carried by the separate and distinct delivery agents) and, in response to receiving notification of the change of the intended location and/or an updated delivery location, the control circuit 102 reroutes the shipment to another of the delivery agents for final delivery thereof.

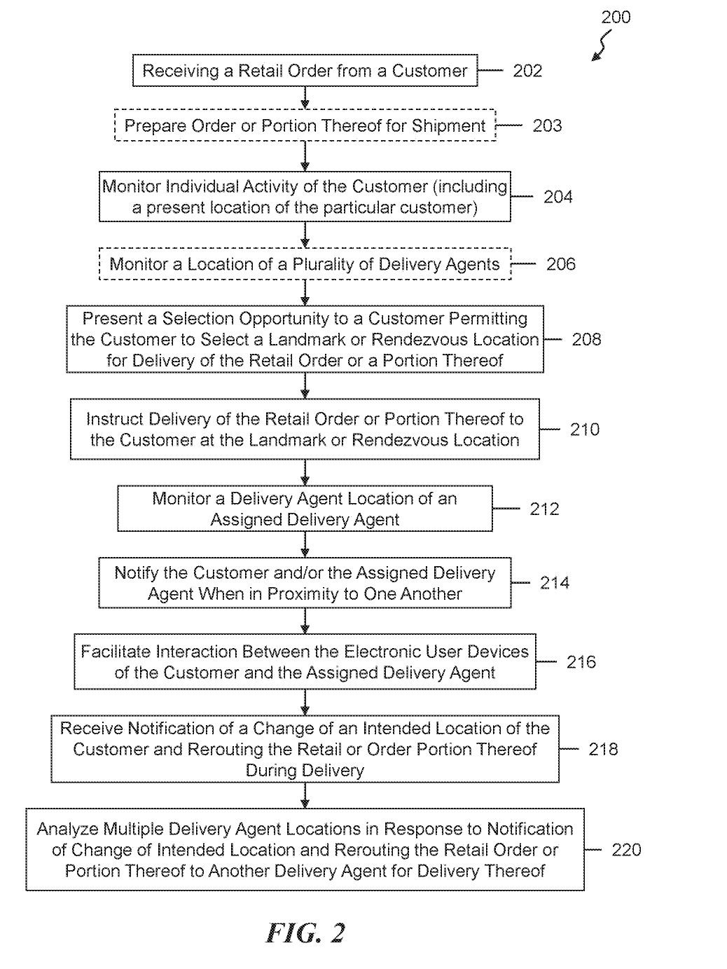

FIG. 2 illustrates a method 200 for delivery of products to a customer away from a home address. By one approach, the method of delivering products 200 includes receiving 202 a retail order from a particular customer, monitoring 204 individual activity of the particular customer including a present location of the particular customer, via an electronic user device associated with the particular customer, presenting 208 a selection opportunity, via a shopping user interface configured to operate on the electronic user interface associated with the particular customer, the selection opportunity permitting the particular customer to select a landmark or rendezvous location for delivery of the retail order or a portion thereof, and instructing 210 delivery of the retail order or the portion thereof to the particular customer at the landmark or rendezvous location, via a delivery user interface operating on a delivery agent user device. To that end, the method may include analyzing a customer itinerary for the particular customer and identifying alternative delivery locations (besides a typically mailing or street address) to present to the particular customer in response to a determination that the particular customer is scheduled to be away from home or an initial delivery location.

As illustrated in FIG. 2, the method 200 also may include preparing 203 an order or portion thereof for shipment to the particular customer. In step 206, the method may monitor a location of a plurality of delivery agents. As mentioned above, by monitoring a plurality of delivery agents, a suitable (or several suitable) delivery agents may be identified and provided an opportunity to deliver a retail order or portion thereof.

After one of the delivery agents has been assigned delivery of a shipment the delivery agent provided instructions regarding the landmark or rendezvous location, the method 200 may monitor 212 a delivery agent location of an assigned delivery agent tasked with delivery of the shipment. Further, in step 214, the method may notify the customer and/or the assigned delivery agent when the two are in proximity to one another, i.e., when the customer and the assigned delivery agent are within a predetermine distance from one another.

In step 216, the method facilitates interaction between the electronic user devices of the customer and the assigned delivery agent, such as, for example, when the particular customer and the assigned delivery agent are within a certain proximity to one another.

In another aspect, the method 200 may include receiving notification 218 regarding a change of an intended location of a particular customer such that the shipment requires an updated delivery location and rerouting the retail order or portion thereof, such as, for example, during delivery of the shipment. Further, the method 200 may include analyzing 220 multiple delivery agent locations in response to the notification of a change of intended location of the particular customer and rerouting the retail order or portion thereof to another delivery agent for delivery thereof.

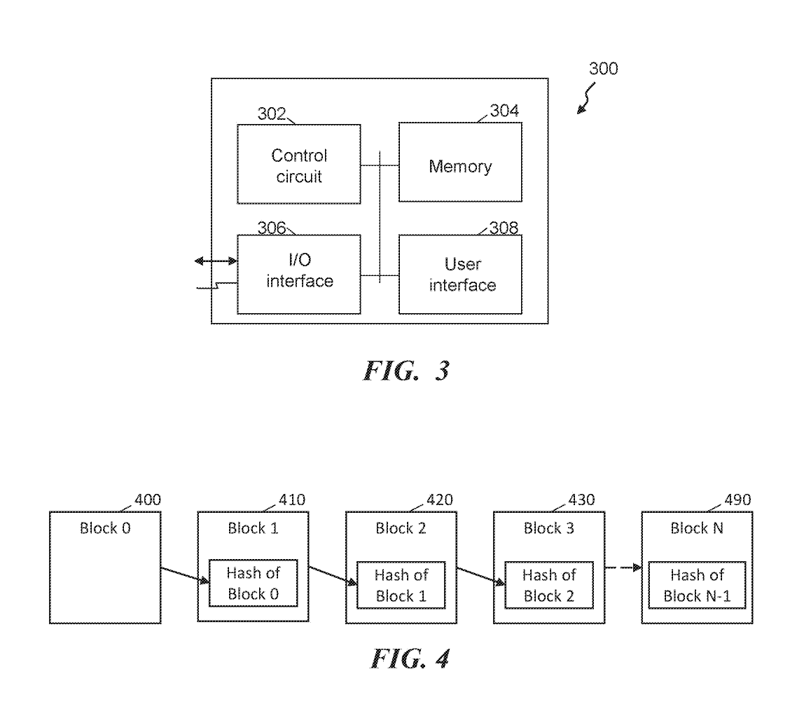

The methods, techniques, systems, devices, services, servers, sources and the like described herein may be utilized, implemented and/or run on many different types of devices and/or systems. Referring to FIG. 3, there is illustrated a system 300 that may be used for any such implementations, in accordance with some embodiments for delivering products to a customer away from home. One or more components of the system 300 may be used to implement any system, apparatus or device mentioned above or below, or parts of such systems, apparatuses or devices, such as for example any of the above or below mentioned systems, databases, devices, parts thereof, and the like. However, the use of the system 300 or any portion thereof is certainly not required.

By way of example, the system 300 may include one or more control circuits 302, memory 304, and input/output (I/O) devices and/or interfaces 306. Some embodiments further include one or more user interfaces 308. The control circuit 302 typically comprises one or more processors and/or microprocessors. The memory 304 stores the operational code or set of instructions that is executed by the control circuit 302 and/or processor to implement the functionality of the systems and devices described herein, parts thereof, and the like. In some embodiments, the memory 304 may also store some or all of particular data that may be needed to monitor activity of customers and data regarding retail orders.

It is understood that the control circuit 302 and/or processor may be implemented as one or more processor devices as are well known in the art. Similarly, the memory 304 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 304 is shown as internal to the system 300; however, the memory 304 can be internal, external or a combination of internal and external memory. Additionally, the system typically includes a power supply (not shown), which may be rechargeable, and/or it may receive power from an external source. While FIG. 3 illustrates the various components being coupled together via a bus, it is understood that the various components may actually be coupled to the control circuit 302 and/or one or more other components directly.

Generally, the control circuit 302 and/or electronic components of the system 300 can comprise fixed-purpose hard-wired platforms or can comprise a partially or wholly programmable platform. These architectural options are well known and understood in the art and require no further description here. The system and/or control circuit 302 can be configured (for example, by using corresponding programming as will be well understood by those skilled in the art) to carry out one or more of the steps, actions, and/or functions described herein. In some implementations, the control circuit 302 and the memory 304 may be integrated together, such as in a microcontroller, application specification integrated circuit, field programmable gate array or other such device, or may be separate devices coupled together.

The I/O interface 306 allows wired and/or wireless communication coupling of the system 300 to external components and/or or systems. Typically, the I/O interface 306 provides wired and/or wireless communication (e.g., Wi-Fi, Bluetooth, cellular, RF, and/or other such wireless communication), and may include any known wired and/or wireless interfacing device, circuit and/or connecting device, such as but not limited to one or more transmitter, receiver, transceiver, etc.

The user interface 308 may be used for user input and/or output display. For example, the user interface 308 may include any known input devices, such one or more buttons, knobs, selectors, switches, keys, touch input surfaces, audio input, and/or displays, etc. Additionally, the user interface 308 include one or more output display devices, such as lights, visual indicators, display screens, etc. to convey information to a user, such as but not limited to retail orders, delivery routes, mapping information, communication information (e.g., text messages, emails, etc.), status information, notifications, errors, conditions, and/or other such information. Similarly, the user interface 308 in some embodiments may include audio systems that can receive audio commands or requests verbally issued by a user, and/or output audio content, alerts and the like.

As noted above, one or more of the delivery agents may be crowd-sourced from a number of unaffiliated, separate and distinct delivery agents that have accessed a delivery agent interface. Further, the control circuits 102, 302 may be configured to authenticate the particular customer and assigned delivery agent. More particularly, the control circuit may authenticate delivery of the retail order or the portion thereof by securely storing data in data blocks so that it cannot be modified after storage. For example, the system 100 may employ a computer memory storing computer readable instructions configured to create a genesis block of a chain, compute a hash of the genesis block, and create a proof standard of the chain. Further, the chain may be stored on multiple nodes as at least one of a distributed database or a shared ledger such that modifications to any one copy of the chain would be detectable when the system attempts to achieve consensus prior to adding a new block to the chain. In another aspect, at least some of the blocks in the chain are created by nodes that include at least one of: the particular customer via the electronic user device associated therewith, a retail entity via the control circuit, or an assigned delivery agent. In another configuration, the control circuit 102 authenticates delivery of the retail order or portion thereof via DNA labeling and the system further comprises a DNA scanner and a delivery agent database having profiles of the delivery agents.

Descriptions of some embodiments of blockchain technology are provided with reference to FIG. 4-9 herein. In some embodiments of the invention described above, blockchain technology may be utilized to record retail orders, record delivery records, and associated transactions, authenticate delivery agents (such as when a delivery is transferred from one delivery agent to another), provide payment to delivery agents for their potion of the delivery, authenticate a package being delivered by delivery agents to a customer during delivery (such as to verify no package tampering occurred), and to use DNA labeling and mapping to verify no package tampering occurred (such as, for example, by having a package wrapped in a material that picks up DNA of those contacting the package and then using this DNA to detect or verify that only authorized persons or authorized handlers have contacted the package, identify removal of DNA information to verify that no tampering has occurred, identifying any irregular DNA deposits, and/or ensuring proper DNA information is properly added to the blockchain to verify that no package tampering has occurred). Further, blockchain technology may be used with one or more of the user devices, databases, systems, or portions thereof described herein that may comprise a node in a distributed blockchain system storing a copy of the blockchain record. Updates to the blockchain may comprise transfer of items, sales information, new data, delivery confirmation, or authentication and one or more nodes on the system may be configured to incorporate one or more updates into blocks to add to the distributed database.

Distributed database and shared ledger database generally refer to methods of peer-to-peer record keeping and authentication in which records are kept at multiple nodes in the peer-to-peer network instead of kept at a trusted party. A blockchain may generally refer to a distributed database that maintains a growing list of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

In some embodiments, a blockchain system comprises a distributed timestamp server comprising a plurality of nodes configured to generate computational proof of record integrity and the chronological order of its use for content, trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash. In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it. A digital currency implemented on a blockchain system is described by Satoshi Nakamoto in “Bitcoin: A Peer-to-Peer Electronic Cash System” (http://bitcoin.org/bitcoin.pdf), the entirety of which is incorporated herein by reference.

Now referring to FIG. 4, an illustration of a blockchain according to some embodiments is shown. In some embodiments, a blockchain comprises a hash chain or a hash tree in which each block added in the chain contains a hash of the previous block. In FIG. 4, block 0 i400 represents a genesis block of the chain. Block 1 410 contains a hash of block 0 400, block 2 420 contains a hash of block 1 410, block 3 430 contains a hash of block 2 420, and so forth. Continuing down the chain, block N contains a hash of block N-1. In some embodiments, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of transaction and/or activity records.

In some embodiments, blocks may contain rules and data for authorizing different types of actions and/or parties who can take action. In some embodiments, transaction and block forming rules may be part of the software algorithm on each node. When a new block is being formed, any node on the system can use the prior records in the blockchain to verify whether the requested action is authorized. For example, a block may contain a public key of an owner of an asset that allows the owner to show possession and/or transfer the asset using a private key. Nodes may verify that the owner is in possession of the asset and/or is authorized to transfer the asset based on prior transaction records when a block containing the transaction is being formed and/or verified. In some embodiments, rules themselves may be stored in the blockchain such that the rules are also resistant to tampering once created and hashed into a block. In some embodiments, the blockchain system may further include incentive features for nodes that provide resources to form blocks for the chain. For example, in the Bitcoin system, “miners' are nodes that compete to provide proof-of-work to form a new block, and the first successful miner of a new block earns Bitcoin currency in return.

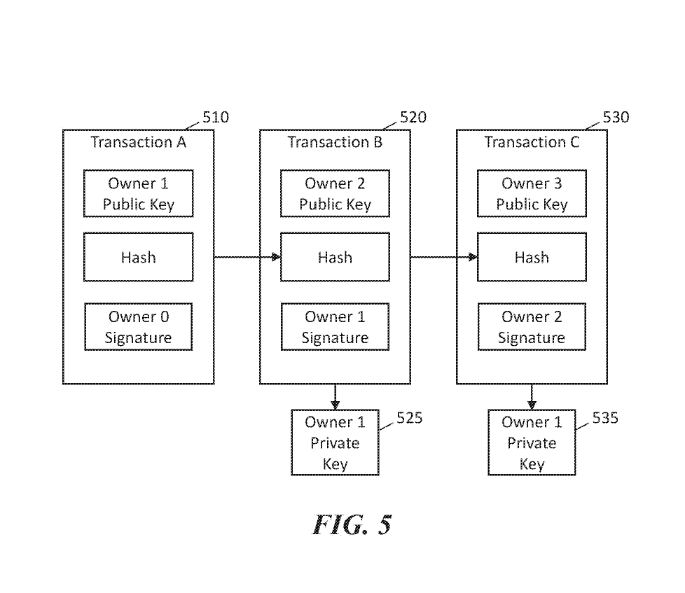

Now referring to FIG. 5, an illustration of blockchain based transactions according to some embodiments is shown. In some embodiments, the blockchain illustrated in FIG. 5 comprises a hash chain protected by private/public key encryption. Transaction A 510 represents a transaction recorded in a block of a blockchain showing that owner 1 (recipient) obtained an asset from owner 0 (sender). Transaction A 510 contains owner's 1 public key and owner 0's signature for the transaction and a hash of a previous block. When owner 1 transfers the asset to owner 2, a block containing transaction B 520 is formed. The record of transaction B 520 comprises the public key of owner 2 (recipient), a hash of the previous block, and owner 1's signature for the transaction that is signed with the owner 1's private key 525 and verified using owner 1's public key in transaction A 510. When owner 2 transfers the asset to owner 3, a block containing transaction C 530 is formed. The record of transaction C 530 comprises the public key of owner 3 (recipient), a hash of the previous block, and owner 2's signature for the transaction that is signed by owner 2's private key 535 and verified using owner 2's public key from transaction B 220. In some embodiments, when each transaction record is created, the system may check previous transaction records and the current owner's private and public key signature to determine whether the transaction is valid. In some embodiments, transactions are broadcasted in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double spending the asset. The transactions in FIG. 5 are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

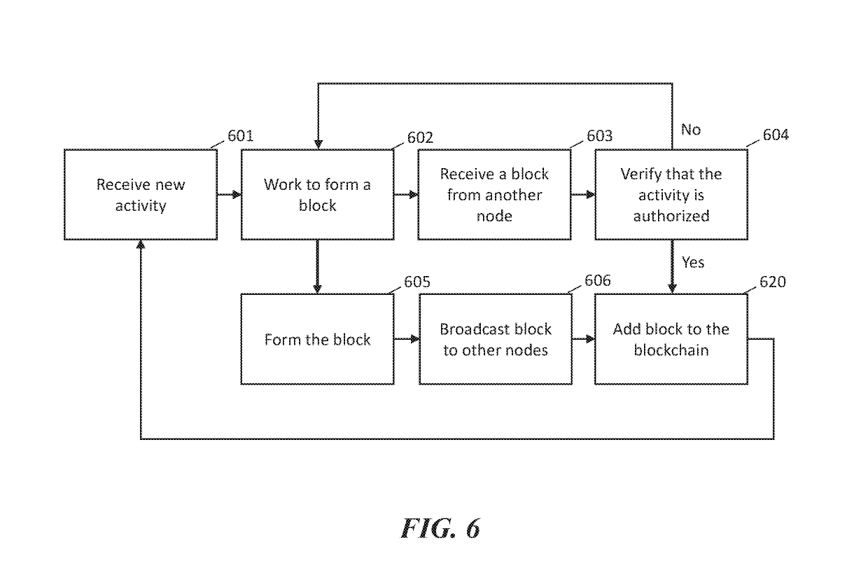

Now referring to FIG. 6, a flow diagram according to some embodiments is shown. In some embodiments, the steps shown in FIG. 6 may be performed by a processor-based device, such as a computer system, a server, a distributed server, a timestamp server, a blockchain node, and the like. In some embodiments, the steps in FIG. 6 may be performed by one or more of the nodes in a system using blockchain for record keeping.

In step 601, a node receives a new activity. The new activity may comprise an update to the record being kept in the form of a blockchain. In some embodiments, for blockchain supported digital or physical asset record keeping, the new activity may comprise an asset transaction. In some embodiments, the new activity may be broadcasted to a plurality of nodes on the network prior to step 601. In step 602, the node works to form a block to update the blockchain. In some embodiments, a block may comprise a plurality of activities or updates and a hash of one or more previous block in the blockchain. In some embodiments, the system may comprise consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem for form a nonce in order to form a block. In some embodiments, the node may be configured to verify that the activity is authorized prior to working to form the block. In some embodiments, whether the activity is authorized may be determined based on records in the earlier blocks of the blockchain itself.

After step 602, if the node successfully forms a block in step 605 prior to receiving a block from another node, the node broadcasts the block to other nodes over the network in step 606. In some embodiments, in a system with incentive features, the first node to form a block may be permitted to add incentive payment to itself in the newly formed block. In step 620, the node then adds the block to its copy of the blockchain. In the event that the node receives a block formed by another node in step 603 prior to being able to form the block, the node works to verify that the activity recorded in the received block is authorized in step 604. In some embodiments, the node may further check the new block against system consensus rules for blocks and activities to verify whether the block is properly formed. If the new block is not authorized, the node may reject the block update and return to step 602 to continue to work to form the block. If the new block is verified by the node, the node may express its approval by adding the received block to its copy of the blockchain in step 620. After a block is added, the node then returns to step 601 to form the next block using the newly extended blockchain for the hash in the new block.

In some embodiments, in the event one or more blocks having the same block number is received after step 620, the node may verify the later arriving blocks and temporarily store these block if they pass verification. When a subsequent block is received from another node, the node may then use the subsequent block to determine which of the plurality of received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 601.

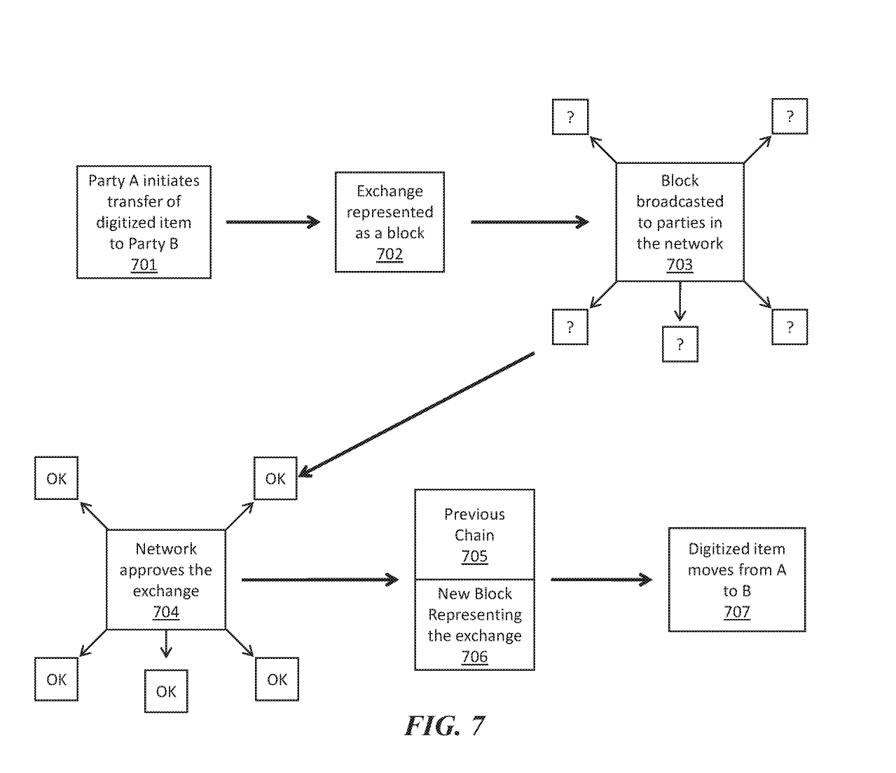

Now referring to FIG. 7, a process diagram a blockchain update according to some implementations in shown. In step 701, party A initiates the transfer of a digitized item to party B. In some embodiments, the digitized item may comprise a digital currency, a digital asset, a document, rights to a physical asset, etc. In some embodiments, Party A may prove that he has possession of the digitized item by signing the transaction with a private key that may be verified with a public key in the previous transaction of the digitized item. In step 702, the exchange initiated in step 701 is represented as a block. In some embodiments, the transaction may be compared with transaction records in the longest chain in the distributed system to verify part A's ownership. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-space, etc. may be used in the system. In some embodiments, the node that is first to form the block may earn a reward for the task as incentive. For example, in the Bitcoin system, the first node to provide prove of work to for block the may earn a Bitcoin. In some embodiments, a block may comprise one or more transactions between different parties that are broadcasted to the nodes. In step 703, the block is broadcasted to parties in the network. In step 704, nodes in the network approve the exchange by examining the block that contains the exchange. In some embodiments, the nodes may check the solution provided as proof-of-work to approve the block. In some embodiments, the nodes may check the transaction against the transaction record in the longest blockchain in the system to verify that the transaction is valid (e.g. party A is in possession of the asset he/she s seeks to transfer). In some embodiments, a block may be approved with consensus of the nodes in the network. After a block is approved, the new block 706 representing the exchange is added to the existing chain 705 comprising blocks that chronologically precede the new block 706. The new block 706 may contain the transaction(s) and a hash of one or more blocks in the existing chain 705. In some embodiments, each node may then update their copy of the blockchain with the new block and continue to work on extending the chain with additional transactions. In step 707, when the chain is updated with the new block, the digitized item is moved from party A to party B.

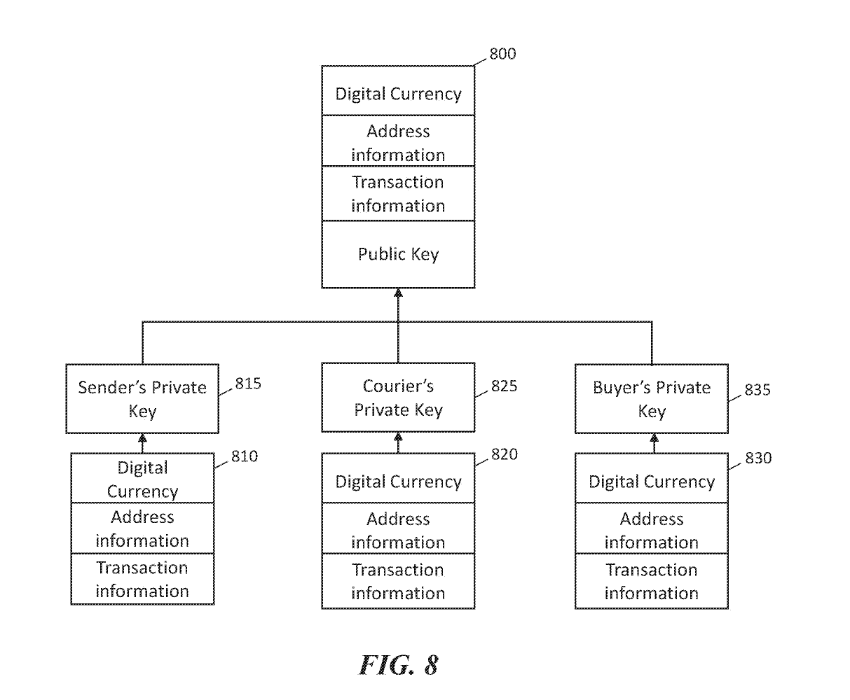

Now referring to FIG. 8, a diagram of a blockchain according to some embodiments in shown. FIG. 8 comprises an example of an implementation of a blockchain system for delivery service record keeping. The delivery record 800 comprises digital currency information, address information, transaction information, and a public key associated with one or more of a sender, a courier, and a buyer. In some embodiments, nodes associated the sender, the courier, and the buyer may each store a copy of the delivery record 810, 820, and 830 respectively. In some embodiments, the delivery record 800 comprises a public key that allows the sender, the courier, and/or the buyer to view and/or update the delivery record 800 using their private keys 815, 825, and the 835 respectively. For example, when a package is transferred from a sender to the courier, the sender may use the sender's private key 815 to authorize the transfer of a digital asset representing the physical asset from the sender to the courier and update the delivery record with the new transaction. In some embodiments, the transfer from the seller to the courier may require signatures from both the sender and the courier using their respective private keys. The new transaction may be broadcasted and verified by the sender, the courier, the buyer, and/or other nodes on the system before being added to the distributed delivery record blockchain. When the package is transferred from the courier to the buyer, the courier may use the courier's private key 825 to authorize the transfer of the digital asset representing the physical asset from the courier to the buyer and update the delivery record with the new transaction. In some embodiments, the transfer from the courier to the buyer may require signatures from both the courier and the buyer using their respective private keys. The new transaction may be broadcasted and verified by the sender, the courier, the buyer, and/or other nodes on the system before being added to the distributed delivery record blockchain.

With the scheme shown in FIG. 8, the delivery record may be updated by one or more of the sender, courier, and the buyer to form a record of the transaction without a trusted third party while preventing unauthorized modifications to the record. In some embodiments, the blockchain based transactions may further function to include transfers of digital currency with the completion of the transfer of physical asset. With the distributed database and peer-to-peer verification of a blockchain system, the sender, the courier, and the buyer can each have confidence in the authenticity and accuracy of the delivery record stored in the form of a blockchain.

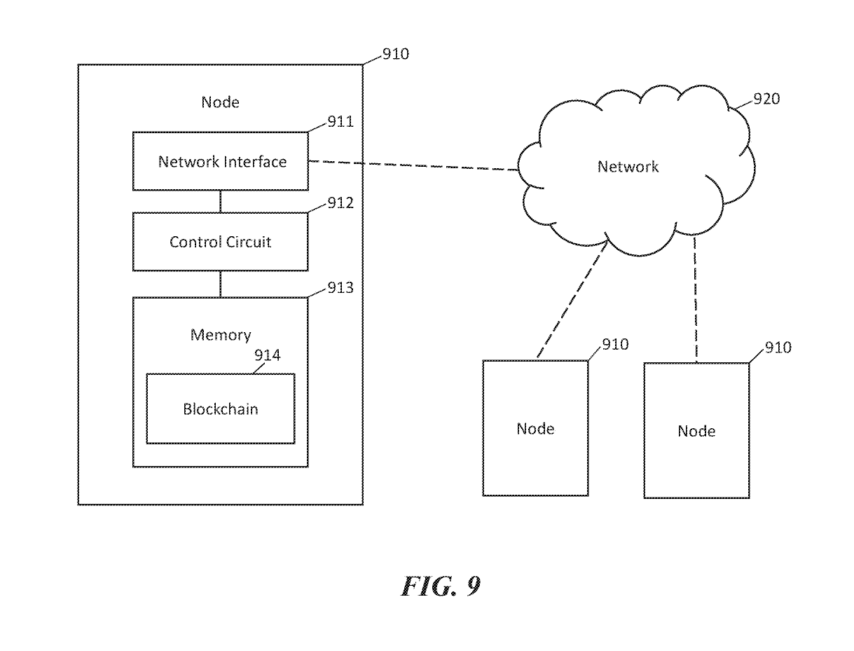

Now referring to FIG. 9, a system according to some embodiments is shown. A distributed blockchain system comprises a plurality of nodes 910 communicating over a network 920. In some embodiments, the nodes 910 may comprise a distributed blockchain server and/or a distributed timestamp server. In some embodiments, one or more nodes 910 may comprise or be similar to a “miner” device on the Bitcoin network. Each node 910 in the system comprises a network interface 911, a control circuit 912, and a memory 913.

The control circuit 912 may comprise a processor, a microprocessor, and the like and may be configured to execute computer readable instructions stored on a computer readable storage memory 913. The computer readable storage memory may comprise volatile and/or non-volatile memory and have stored upon it a set of computer readable instructions which, when executed by the control circuit 912, causes the node 910 update the blockchain 914 stored in the memory 913 based on communications with other nodes 910 over the network 920. In some embodiments, the control circuit 912 may further be configured to extend the blockchain 914 by processing updates to form new blocks for the blockchain 914. Generally, each node may store a version of the blockchain 914, and together, may form a distributed database. In some embodiments, each node 910 may be configured to perform one or more steps described with reference to FIGS. 6-7 herein.

The network interface 911 may comprise one or more network devices configured to allow the control circuit to receive and transmit information via the network 920. In some embodiments, the network interface 911 may comprise one or more of a network adapter, a modem, a router, a data port, a transceiver, and the like. The network 920 may comprise a communication network configured to allow one or more nodes 910 to exchange data. In some embodiments, the network 920 may comprise one or more of the Internet, a local area network, a private network, a virtual private network, a home network, a wired network, a wireless network, and the like. In some embodiments, the system does not include a central server and/or a trusted third party system. Each node in the system may enter and leave the network at any time.

With the system and processes shown in, once a block is formed, the block cannot be changed without redoing the work to satisfy census rules thereby securing the block from tampering. A malicious attacker would need to provide proof standard for each block subsequent to the one he/she seeks to modify, race all other nodes, and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. Bitcoin is an example of a blockchain backed currency. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the transaction records are computationally impractical to reverse. As such, sellers are protected from fraud and buyers are protected by the routine escrow mechanism.

In some embodiments, a blockchain may use to secure digital documents such as digital cash, intellectual property, private financial data, chain of title to one or more rights, real property, digital wallet, digital representation of rights including, for example, a license to intellectual property, digital representation of a contractual relationship, medical records, security clearance rights, background check information, passwords, access control information for physical and/or virtual space, and combinations of one of more of the foregoing that allows online interactions directly between two parties without going through an intermediary. With a blockchain, a trusted third party is not required to prevent fraud. In some embodiments, a blockchain may include peer-to-peer network timestamped records of actions such as accessing documents, changing documents, copying documents, saving documents, moving documents, or other activities through which the digital content is used for its content, as an item for trade, or as an item for remuneration by hashing them into an ongoing chain of hash-based proof-of-work to form a record that cannot be changed in accord with that timestamp without redoing the proof-of-work.

In some embodiments, in the peer-to-peer network, the longest chain proves the sequence of events witnessed, proves that it came from the largest pool of processing power, and that the integrity of the document has been maintained. In some embodiments, the network for supporting blockchain based record keeping requires minimal structure. In some embodiments, messages for updating the record are broadcast on a best-effort basis. Nodes can leave and rejoin the network at will and may be configured to accept the longest proof-of-work chain as proof of what happened while they were away.

In some embodiments, a blockchain based system allows content use, content exchange, and the use of content for remuneration based on cryptographic proof instead of trust, allowing any two willing parties to employ the content without the need to trust each other and without the need for a trusted third party. In some embodiments, a blockchain may be used to ensure that a digital document was not altered after a given timestamp, that alterations made can be followed to a traceable point of origin, that only people with authorized keys can access the document, that the document itself is the original and cannot be duplicated, that where duplication is allowed and the integrity of the copy is maintained along with the original, that the document creator was authorized to create the document, and/or that the document holder was authorized to transfer, alter, or otherwise act on the document.

As used herein, in some embodiments, the term blockchain may refer to one or more of a hash chain, a hash tree, a distributed database, and a distributed ledger. In some embodiments, blockchain may further refer to systems that uses one or more of cryptography, private/public key encryption, proof standard, distributed timestamp server, and inventive schemes to regulate how new blocks may be added to the chain. In some embodiments, blockchain may refer to the technology that underlies the Bitcoin system, a “sidechain” that uses the Bitcoin system for authentication and/or verification, or an alternative blockchain (“altchain”) that is based on bitcoin concept and/or code but are generally independent of the Bitcoin system.

Descriptions of embodiments of blockchain technology are provided herein as illustrations and examples only. The concepts of the blockchain system may be variously modified and adapted for different applications.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. A retail product delivery system for delivery of products to a customer away from home, the retail product delivery system comprising:
one or more electronic user devices configured to be carried by one or more delivery agents and one or more customer recipients;
a shopping user interface configured to operate on at least one of the electronic user devices;
a delivery user interface configured to operate on at least one of the electronic user devices;
a control circuit in communication with at least some of the electronic user devices, the control circuit configured to:
receive a retail order from a particular customer;
monitor individual activity of the particular customer associated with the retail order, including a present location of the particular customer, via an electronic user device associated with the particular customer;
present a selection opportunity, via the shopping user interface, based, in part, on readings from the electronic user device associated with the particular customer, the selection opportunity permitting the particular customer to select a landmark or rendezvous location for delivery of the retail order or a portion thereof; and
instruct delivery of the retail order or the portion thereof to the particular customer at the landmark or rendezvous location, via the delivery user interface operating on one of the electronic user devices associated with the delivery agents.

2. The retail product delivery system of claim 1 wherein the control circuit is further configured to:
monitor a delivery agent location of an assigned delivery agent tasked with delivery of the retail order or the portion thereof; and
notify the particular customer, via the electronic user device associated with the particular customer and the assigned delivery agent, via the one of the electronic user devices associated with the assigned delivery agent, when the particular customer and the assigned delivery agent are within a predetermined distance from one another.

3. The retail product delivery system of claim 2 wherein, upon a determination that the particular customer and the assigned delivery agent are within the predetermined distance from one another, the control circuit facilitating interaction between the electronic user device associated with the particular customer and the electronic user device associated with the assigned delivery agent.

4. The retail product delivery system of claim 1 wherein monitoring individual activity of the particular customer comprises receiving notification of a change of an intended location of the particular customer and the control circuit being further configured to reroute the retail order or the portion thereof during delivery.

5. The retail product delivery system of claim 4 wherein the control circuit is further configured to analyze multiple delivery agent locations via the electronic user devices carried by separate and distinct delivery agents and in response to receiving the notification of the change in the intended location, rerouting the retail order or the portion thereof to another of the delivery agents for delivery.

6. The retail product delivery system of claim 1 wherein the control circuit is further configured to present a delivery opportunity to one or more delivery agents via the delivery user interface.

7. The retail product delivery system of claim 6 wherein the control circuit is further configured to detect whether one of the delivery agents is within a predetermined distance from at least one of: a distribution location, a shipping location, another delivery agent with a delivery location proximate the landmark or rendezvous location of a particular retail order, or the landmark or rendezvous location of the particular retail order.

8. The retail product delivery system of claim 7 wherein the control circuit is further configured to monitor locations of a plurality of delivery agents via the electronic user interfaces associated therewith.

9. The retail product delivery system of claim 1 further comprising a delivery agent database having capabilities of at least a plurality of delivery agents and associated delivery vehicles therein.

10. The retail product delivery system of claim 1 wherein the control circuit is further configured to receive delivery requests from the particular customer and a customer itinerary from the electronic user device associated with the particular customer.

11. The retail product delivery system of claim 10 wherein the control circuit is further configured to analyze the customer itinerary and identify alternative delivery locations to present to the particular customer via the shopping user interface, in response to a determination that the particular customer is scheduled to be away from an initial delivery location or a home street address.

12. The retail product delivery system of claim 1 wherein some of the delivery agents are crowd-sourced via a plurality of delivery user interfaces operating on the electronic user devices.

13. The retail product delivery system of claim 1 wherein the control circuit is further configured to authenticate the particular customer and an assigned delivery agent.

14. The retail product delivery system of claim 1 wherein the control circuit authenticates delivery of the retail order or the portion thereof by securely storing data in data blocks so that it cannot be modified after storage.

15. The retail product delivery system of claim 14 further comprising a computer memory storing computer readable instructions configured to create a genesis block of a chain, compute a hash of the genesis block, and create a proof standard of the chain.

16. The retail product delivery system of claim 15 wherein the chain is stored on multiple nodes as at least one of a distributed database or a shared ledger such that modifications to any one copy of the chain would be detectable when the system attempts to achieve consensus prior to adding a new block to the chain.

17. The retail product delivery system of claim 15 wherein at least some of the blocks in the chain are created by nodes that include at least one of: the particular customer via the electronic user device associated therewith, a retail entity via the control circuit, or an assigned delivery agent.

18. The retail product delivery system of claim 14 wherein the control circuit authenticates delivery of the retail order or portion thereof via DNA labeling and the system further comprises a DNA scanner and a delivery agent database having profiles of the delivery agents.

19. A method for delivering products to a customer away from home, the method comprising:
receiving a retail order from a particular customer;
monitoring individual activity of the particular customer including a present location of the particular customer, via an electronic user device associated with the particular customer;
presenting a selection opportunity, via a shopping user interface configured to operate on the electronic user interface associated with the particular customer, the selection opportunity permitting the particular customer to select a landmark or rendezvous location for delivery of the retail order or a portion thereof; and
instructing delivery of the retail order or the portion thereof to the particular customer at the landmark or rendezvous location, via a delivery user interface operating on a delivery agent user device.

20. The method of claim 19 further comprising monitoring a delivery agent location of an assigned delivery agent tasked with delivery of the retail order or the portion thereof and notify the particular customer, via the electronic user device associated with the particular customer and the assigned delivery agent, via the delivery agent user device, when the particular customer and the assigned delivery agent are within a predetermined distance from one another.

21. The method of claim 19 further comprising facilitating interaction between the electronic user device associated with the particular customer and the delivery agent user device upon determining that the electronic user device associated with the particular customer and the delivery agent user device are within the predetermined distance from one another.

22. The method of claim 19 further comprising receiving notification of a change of an intended location of the particular customer and rerouting the retail order or the portion thereof during delivery thereof.

23. The method of claim 22 further comprising analyzing multiple delivery agent locations via electronic user devices carried by separate and distinct delivery agents and in response to receiving notification of the change in intended location, rerouting the retail order or portion thereof to another of the delivery agents for delivery.

24. The method of claim 19 further comprising monitoring locations of a plurality of delivery agents via electronic user devices associated with the delivery agents.

25. The method of claim 19 further comprising analyzing a customer itinerary for the particular customer and identifying alternative delivery locations to present to the particular customer via the electronic user device associated therewith on the shopping user interface, in response to determining that the particular customer is scheduled to be away from an initial delivery location.
